(19) United States
(12) Patent Application Publication
(10) Pub. No.: US 2017/0023136 A1
(43) Pub. Date: Jan. 26, 2017

(54) Constant Volume Valve

(71) Applicant: Szu Chia Chen, Taoyuan (TW)

(72) Inventor: Szu Chia Chen, Taoyuan (TW)

(21) Appl. No.: 15/256,516

(22) Filed: Sep. 3, 2016

Related U.S. Application Data
(60) Provisional application No. 62/217,021, filed on Sep. 11, 2015.

(30) Foreign Application Priority Data
Jul. 23, 2015 (TW) 104211860

(51) Int. Cl. F16K 3/26; F16K 31/06; F16K 31/363; F16K 1/12

(52) U.S. Cl. CPC F16K 3/26; F16K 1/12; F16K 31/0658; F16K 31/0668; F16K 31/0648; F16K 31/363

(57) ABSTRACT

A constant volume valve provided with body, plunger and controller. The body has inlet port, outlet port, and a chamber for pressurized fluid to fill. The inlet port is connected to pressurized fluid source. The plunger is inside the body and is shorter than the distance between the inlet and outlet ports. The two end surfaces of the plunger function as two poppet valves. The controller moves the plunger in a linear back-and-forth motion. The plunger blocks the inlet port and opens outlet port when it moves to one end, and it blocks the outlet port and opens the inlet port when it moves to the other. The pressurized fluid fills inside the body when the inlet port is opened, then it expands and overflows when the outlet port is opened. The invention is particularly useful in a CO₂ regulator for the planted aquarium.

### BACKGROUND OF THE INVENTION

1. Field of the Invention

The present invention relates to a constant volume valve that makes use of the pressure in the source fluid to provide a constant volume output.

2. Description of the Related Art

Conventional method for delivering constant volume of fluid, gas or liquid, is to regulate the “ON” time of a constant flow pump using a micro-computer. Although it works, it costs. It would be desirable to have a constant volume delivering valve which is simple and economical to produce.

### SUMMARY OF THE INVENTION

The present invention provides a valve that simplifies the constant volume delivering mechanism at a lower cost. By making use of the source pressure, the fluid stored inside the valve is compressed. As the valve opened, the fluid depressurized and its volume expands. The extra volume of the fluid overflows to the outlet port thus providing a constant volume output.

To achieve the aforementioned purpose, the invention includes a body, a plunger, and a controller. The body provides an inlet port, an outlet port and a chamber in between to store the fluid. The inlet port is connected to a pressurized source. The plunger which resides in the chamber has two blocking surfaces that function as poppet valves on both ends. The size of the plunger is shorter than the distance between the inlet and outlet ports. The position of the plunger is controlled by the controller in a linear way such that it either stops in one end blocking the inlet port, or stops in the other end blocking the outlet port.

Another embodiment of the invention uses a sliding spool instead of a plunger. Unlike a conventional spool valve, the inlet and outlet ports are never directly connected to form a path. Again it has a body with inlet and outlet ports on the top and bottom. The inlet port is connected to a pressurized fluid source. The spool inside the body has lands on the left and right sides, and a chamber in between. As the land on the left blocks the outlet port, the chamber is connected to the inlet port. On the other hand when the land on the right blocks the inlet port, the volume is connected to the outlet port.

### BRIEF DESCRIPTION OF THE DRAWINGS

FIG. 1 is a schematic, cross-sectional view of a first embodiment of the present invention, illustrating the plunger is blocking the outlet port.

FIG. 2 is a schematic, cross-sectional view of a first embodiment of the present invention, illustrating the plunger is blocking the inlet port.

FIG. 3 is a schematic, cross-sectional view of a second embodiment of the present invention, illustrating an extra container is connected to the body.

FIG. 4 is a schematic, cross-sectional view of a third embodiment of the present invention, illustrating the volume in the plunger is connected to the inlet port.

FIG. 5 is a schematic, cross-sectional view of a third embodiment of the present invention, illustrating the volume in the plunger is connected to the outlet port.

FIG. 6 is a schematic, cross-sectional view of a fourth embodiment of the present invention, illustrating the volume in the plunger is connected to the inlet port.

FIG. 7 is a schematic, cross-sectional view of a fourth embodiment of the present invention, illustrating the volume in the plunger is connected to the outlet port.

### DETAILED DESCRIPTION OF THE INVENTION

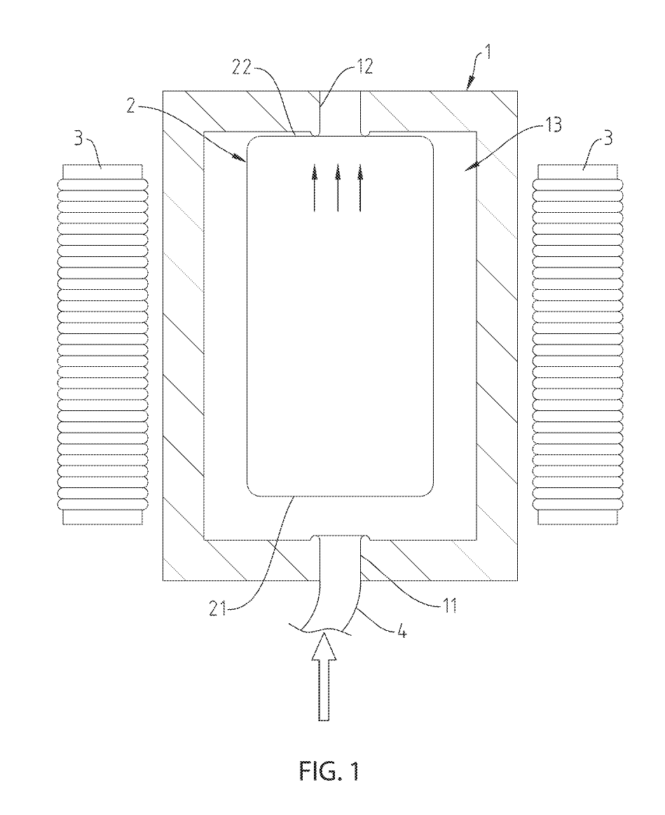

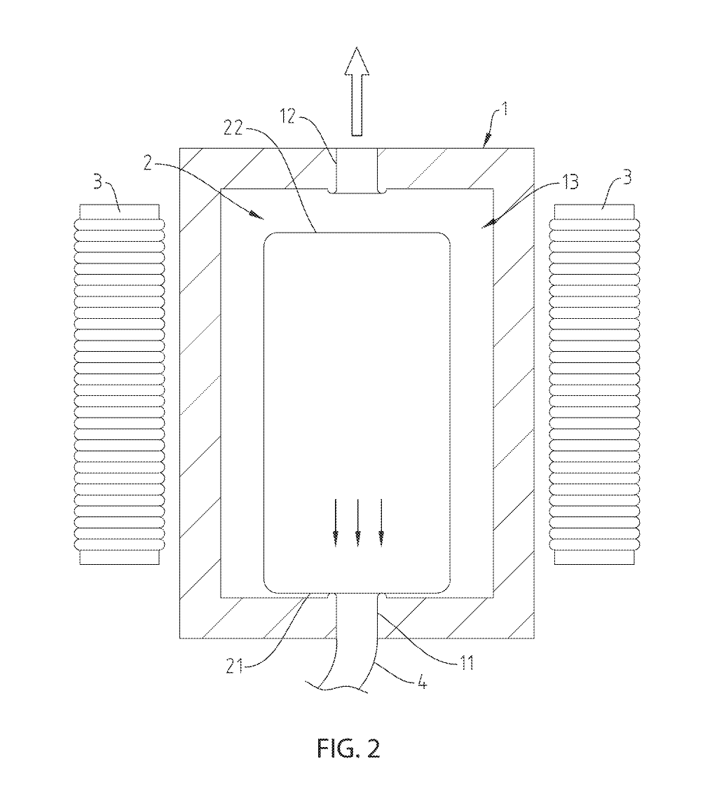

FIG. 1 and FIG. 2 show a first embodiment of the present invention. It provides a body 1, a plunger 2 and a controller 3. The body has an inlet port 11, an outlet port 12 and a connecting chamber 13. The pressurized fluid source 4 is connected to inlet port 11. The fluid can take the form of gas or liquid.

The plunger 2 in the body 1 situated inside the volume 13, has top surface 21 and bottom surface 22 that function as poppet valves near the inlet 11 and outlet port 12. The size of the plunger 2 is shorter than the distance from inlet port 11 to outlet port 12. The plunger 2 is made of metal in this embodiment.

The Controller coil 3 on the side of the body controls the plunger 2 in a back-and-forth motion between inlet port 11 and outlet port 12.

In operation, the controller coil 3 closes the outlet port 12 by moving the plunger 2 against it. This action also opens inlet port 11 by leaving a gap between the plunger end poppet 21 and the inlet port 11. The inlet port 11 and chamber 13 is therefore connected, the pressurized fluid fills the chamber 13. The controller 3 then closes the inlet port 11 by moving the plunger 2 against it. This also opens outlet port 12 by leaving a gap between the plunger poppet 22 and the outlet port 12, thus connecting chamber 13 and outlet port 12. As a result, the fluid stored in the volume is depressurized and expands to its original volume. It overflows through outlet port 12 out of the body 1. By repeating the aforementioned steps, a constant flow can be achieved. The per-cycle output can be regulated by the pressure of the fluid given chamber 13 unchanged. The higher the pressure, the more it outputs and vice versa.

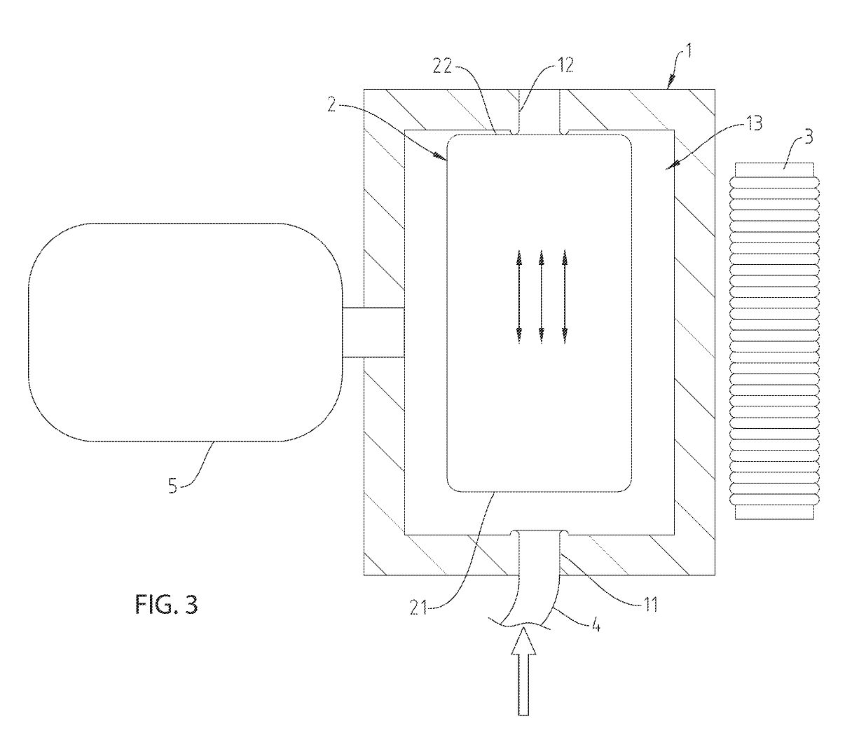

FIG. 3 shows a second embodiment of the invention. The difference from the first embodiment is the addition of a container 5 at one side of the body 1. The volume in the container 5, which connects directly with the body chamber 13, provides extra storage for the fluid thus increases the volume of the output.

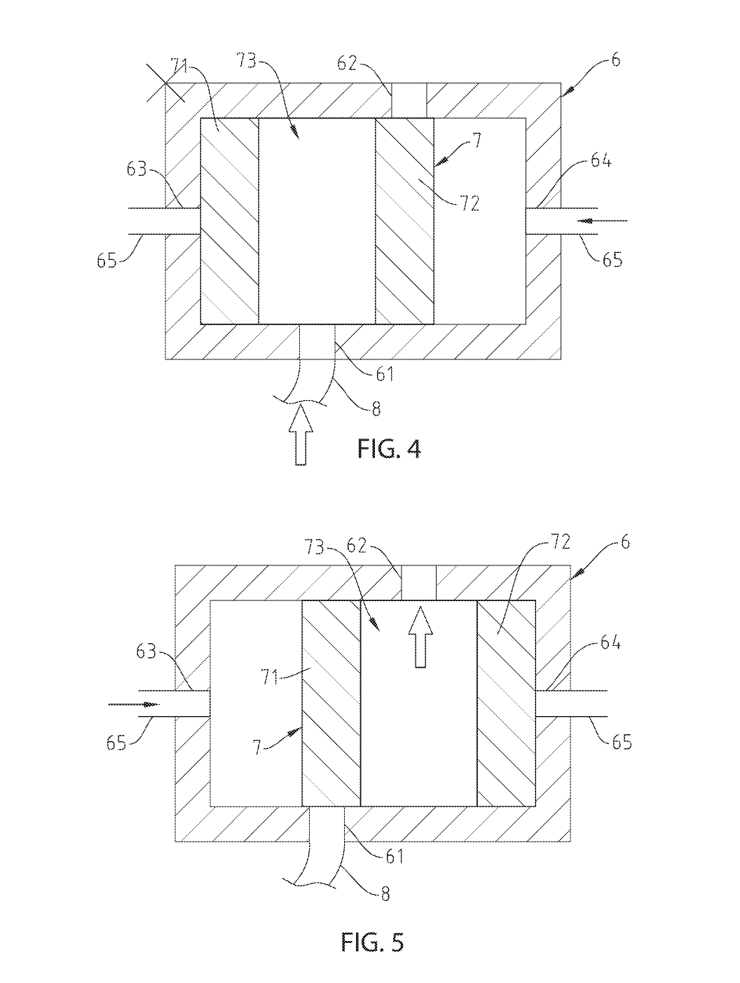

FIG. 4 and FIG. 5 illustrate the third embodiment of the invention. It shows a body 6 and a sliding spool 7. The body 6 has an inlet port 61 on the bottom and an outlet port 62 on the top. The inlet port 61 is connected to pressurized fluid source 8. The body 6 has two additional ports 63 and 64 on both left and right sides when compares to embodiment one and two.

The sliding spool 7 inside the body 6 has two lands 71 and 72 and a chamber 73 in between.

The sliding of the spool is enabled by sending pressurized fluid through the port 63 for a right shift, and to the port 64 for a left shift. When spool shifts to the left, the outlet port 62 is blocked and the chamber 73 connects to the inlet port 61. The pressurized fluid in source 8 enters and fills the chamber 73. Then the spool shifts to the right, the inlet port is blocked and the chamber 73 connects to the outlet port 62. As a result, the fluid stored in the chamber 73 is depressurized and expands to its original volume. It overflows through the outlet port 62 out of the body 6. By repeating the aforementioned steps, a constant volume flow out of body 6 can be achieved.

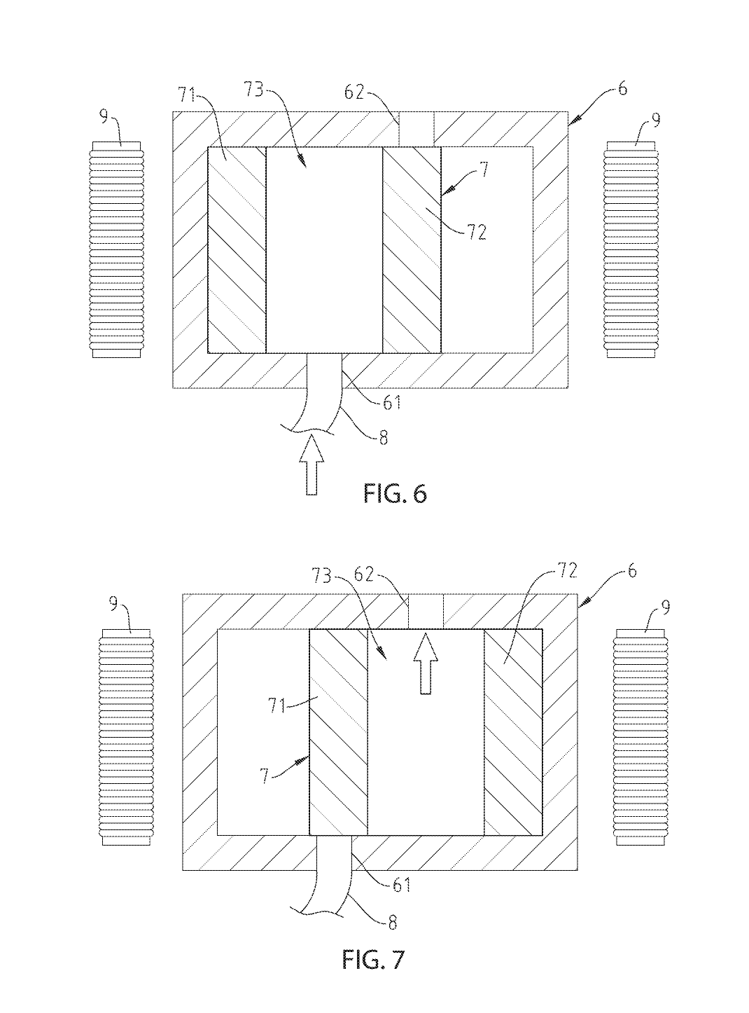

FIG. 6 and FIG. 7 show the fourth embodiment of the invention. The difference from the third embodiment of the invention is the controller coil 9 on both side of the body 6′. The spool can be made of metal. The controller coil 9 shifts the spool to the left such that the outlet port 62′ is blocked and the chamber 73′ connects to the inlet port 61′; or shifts the spool to the right such that the inlet port is blocked and the chamber 73′ connects to the outlet port 62′.

I claim:

1. A constant volume valve providing constant volume of fluid comprising:
a body;
a plunger;
a controller;
The body has a chamber, an inlet port and an outlet port.
The inlet port and outlet port is connected to chamber.
The plunger has first end surface and second end surface that function as poppet valves near the inlet port and outlet port. The length of the plunger 2 is shorter than the distance from inlet port to outlet port.
The shifting of plunger is controlled by controller such that the either the first end surface stop against inlet port, or the second end surface stop against the outlet port.

2. A constant volume valve of claim 1, wherein the controller is a solenoid coil.

3. A constant volume valve of claim 1, further including a container such that the volume in the chamber and container is connected;

4. A constant volume valve providing constant volume of fluid comprising:
a body;
a sliding spool;
The body has inlet port on the bottom and outlet port on the top.
The sliding spool inside the body has two lands and, and a chamber in between.
When spool shifts to the left, the outlet port is blocked and the chamber connects to the inlet port.
When the spool shifts to the right, the inlet port is blocked and the chamber connects to the outlet port

5. A constant volume valve of claim 4, further include two additional ports on both left and right sides. The sliding of the spool is enabled by sending pressurized fluid through these ports for a right shift and left shift.

6. A constant volume valve of claim 4, wherein the controller is a solenoid coil on the side of the body. Part of the spool is made of metal. The controller coil enables the shifting of the sliding spool, in a left or right direction.
